(19) United States
(12) Patent Application Publication
(10) Pub. No.: US 2021/0138294 A1
(43) Pub. Date: May 13, 2021

(54) TABLE ASSEMBLY

(71) Applicant: Joseph Rocci, Burr Ridge, IL (US)

(72) Inventor: Joseph Rocci, Burr Ridge, IL (US)

(21) Appl. No.: 16/677,884

(22) Filed: Nov. 8, 2019

(51) Int. Cl. A63B 21/00; A61G 13/00

(52) U.S. Cl. CPC A63B 21/4029; A61H 2201/0142; A61G 13/009

(57) ABSTRACT

A channel filler is used in a table having a planar surface, where the table has a width and a length, and a plurality of cushions fixedly attached to planar surface. The channel filler includes a compressible body portion configured to compressibly fit into a channel formed between adjacent cushions. The channel extends along the width of the planar surface and is defined by a distance between the adjacent cushions. The compressible body portion has a cross-sectional shape configured to be removeably retained in the channel so as to provide a smooth transition along an upwardly-facing weight-bearing surface of the cushions and between the adjacent cushions.

### BACKGROUND

Support benches and tables are common and are available in many configurations. Most benches and tables have four to six support legs depending on the weight for which they are designed to support. Exercise benches and massage tables often include one or more cushions for user comfort. Some benches and tables may be constructed as a single assembly and may have a single cushion along its length. Other benches and tables may be designed to fold for transport, mixed use, and convenience, such as massage tables, multiple-exercise workout benches, and thus have a hinge or other moveable fastener to permit the table to fold or pivot into multiple sections.

Multi-exercise workout benches also have hinged construction and are designed to pivot between a flat configuration and a chair-like configuration. Each of the folding section may have a cushion affixed to a top surface. This is common in massage tables and multi-exercise workout benches. Due to the folding configuration and plurality of cushions associated with the separate folding sections, a gap is necessarily present between adjacent cushions when in the fixed, unfolded support or flat position. Typically non-folding benches and tables may also be found in doctor's offices, which may have a plurality of cushions with a gap therebetween.

Unfortunately, such a gap creates an uneven surface along the cushions, which is uncomfortable for the user when lying on the table when the table is in the flat configuration, as there is little or no support for the user's body laterally along the gap portion. A need exists for a bench or table having multiple cushions that provides a substantially uniform support surface for a user.

### SUMMARY

In one embodiment, a table assembly includes a table having a planar surface with a top side, a bottom side, a width, and a length, and a plurality of legs extending downwardly from the bottom side of the planar surface, which have sufficient structural integrity so as to support a weight of an object disposed on the planar surface. A plurality of cushions are fixedly to the planar surface along a portion of the length of the planar surface. A channel is formed between adjacent cushions of the plurality of cushions, and extends across a portion of the width of the planar surface. Also included is a channel filler having a compressible body portion having a cross-sectional shape configured so that the channel filler compressibly fits into the channel between the adjacent cushions and extends along the portion of the width of the planar surface. The channel filler is removeably retained in the channel so as to provide a smooth transition on the weight-bearing surface of the cushions and between the adjacent cushions.

In another embodiment, a channel filler is used in a table having a planar surface, where the planar surface has a top side, a bottom side, a width, and a length, and a plurality of cushions fixedly attached to the top side. The channel filler includes a compressible body portion configured to compressibly fit into a channel formed between adjacent cushions. The channel extends along the width of the planar surface and is defined by a distance between the adjacent cushions. The compressible body portion has a cross-sectional shape configured to be removeably retained in the channel so as to provide a smooth transition on the weight-bearing surface of the cushions and between the adjacent cushions.

### BRIEF DESCRIPTION OF THE DRAWINGS

FIG. 1A is a perspective view of a known non-folding table according to one embodiment.

FIG. 1B is a perspective view of a known folding table according to one embodiment.

FIG. 2 is a side view of a folding table according to one embodiment.

FIG. 3 is an enlarged side view of a portion of the table of FIG. 2.

FIG. 4 is an enlarged perspective side view of the table of FIG. 2 showing a channel filler disposed between adjacent cushions, according to one embodiment.

FIG. 5 is a side view of FIG. 4.

FIG. 6 is a perspective view of the channel filler, according to one embodiment.

FIG. 7 is a partial cut-away view of the channel filler of FIG. 6.

FIG. 8 is a perspective view of the channel filler enclosed in a fabric case, according to one embodiment.

FIGS. 9A-9J show various side views of the channel filler of FIG. 6 illustrating the various shapes that may be used, according to some embodiments.

FIGS. 10A-10B show perspective views of the channel filler of FIG. 6 to further illustrate various cross-sectional shapes that may be used, according to some embodiments.

FIGS. 11A-11B shows additional embodiments of the channel filler.

FIG. 12 is a perspective view of a channel filler with a stiffening rod, according to an embodiment.

### DETAILED DESCRIPTION

While the disclosure may be susceptible to embodiment in different forms, there is shown in the drawings, and herein will be described in detail, specific embodiments with the understanding that the present disclosure is to be considered an exemplification of the principles of the disclosure, and is not intended to limit the disclosure to that as illustrated and described herein. Therefore, unless otherwise noted, features disclosed herein may be combined together to form additional combinations that were not otherwise shown for purposes of brevity. It will be further appreciated that in some embodiments, one or more elements illustrated by way of example in a drawings may be eliminated and/or substituted with alternative elements within the scope of the disclosure.

FIG. 1A shows a typical bench or table 102, or more particularly, a non-folding massage table or a table often seen in a doctor's office. The table 102 of FIG. 1B shows a massage table having a configuration that permits folding.

The table 102 may include a frame 106, which may be of a single frame construction, as shown in FIG. 1A, or the frame may have a plurality of interconnected or pivotal frame members configured to permit the table to fold for easy transport or storage, as shown in FIG. 1B.

The table 102 may include a frame 106 (whether folding or non-folding), and may include a planar surface 108 affixed to a portion of the frame. The planar surface 108 may be constructed of any suitable rigid material, such as wood, plastic, metal, and the like. In some embodiments, the planar surface need not be a separate structural element, but rather, may be part of a cushion affixed to the frame, as described below. The table 102 is defined by a width 114 and a length 116. A plurality of legs 120 may extend downwardly from either the frame 106 or from a bottom side 122 of the planar surface. Preferably, legs are sufficiently strong so as to safely support a weight of an object disposed on the planar surface, for example, a human 124, also referred to as a patient, weighing up to 400 pounds. In some embodiments, a frame 106 need not be included if the legs 120 are operatively or pivotally affixed directly to the planar surface 108.

A plurality of cushions 126 may be fixedly attached directly to the frame 106 or to the planar surface 108 along a portion of the length 116 of the table. In some embodiments, the cushions 126 may be formed with a rigid planar base 127, typically made of wood, such that upholstery forming the cushion is attached to the planar base. The cushions are commercially available in various configurations, and the selection of the known table 102 determines the type of cushion used.

The cushions 126 may be substantially planar along its corresponding base 127. The base 127 may attach to the frame 108 or to the planar surface 108. If the cushion 126 does not include a planar base 127, the cushion may attach to the planar surface 108. Each cushion 126 has an upwardly-facing weight-bearing surface 128 upon which the patient 124 lies.

As shown in the figures, and in particular in FIGS. 2-3, a gap or a channel 130 is necessarily formed between the adjacent cushions of the plurality of cushions 126 when the table 102 is configured in the horizontal or unfolded, flat orientation. FIG. 3 is an enlarged view of FIG. 2 and particularly shows the channel 130 under the patient's 122 shoulder area. Although the table 102 shown in FIG. 2 depicts a non-folding configuration, it may also be a folding-type table without departing from the scope of this invention. All embodiments apply to both folding and non-folding tables and exercise benches.

The channel 130 may extend across the width 114 or a portion of the width of the table 102, and is defined by a predetermined distance between the adjacent cushions 126 and by the shape of the edges 136 of the cushions 126. As may be understood from the drawings, the contour of the channel 130 is defined by the contour of the edges 136 of the cushions. For example, cushions having substantially rounded edges form a relatively wide channel, while cushions having a sharper edge create a more V-like channel. Because the shape of the cushion may vary, and in particular, due to the shape of the edges of the cushion, the cross-sectional shape of the contour between adjacent cushions 126 may similarly vary.

Some common commercially available cushions may have rounded edges because such a shape simplifies manufacturing of the cushions, and lowers the cost. Thus, for cushions having rounded edges, a generalized “V-shaped” or tapered shape of the contour of the channel 130 between adjacent cushions 126 is presented. Rounded edges in some embodiments are preferred because right-angle or non-rounded edges in cushions are more difficult to manufacture and require stiffer, denser, and more expensive cushion material or filler. As shown in FIGS. 1A, 1B, and 2-3, and discussed above, the gap or channel 130 formed between adjacent cushions 126 is disadvantageous and undesirable because it reduces user comfort, because limited or no support is provided for the patient 122 in the area of the channel. This may be physically uncomfortable or painful to the patient 122.

FIG. 4 is a perspective view of a portion of the table 102 and in particular, shows two adjacent cushions 126. FIG. 5 is a side view of FIG. 4. To obviate this problem of lack of support in the channel area 130 discussed above, a channel filler 402 may be fitted into the channel 130 and may be held in place with straps 406 operatively affixed to the channel filler.

FIGS. 6-7, show additional detail of the channel filler 402, according to one embodiment. FIG. 6 is a perspective view of the channel filler 402 shown in FIGS. 4-5, while FIG. 7 illustrates a partial cut-away view of the channel filler 402. The channel filler 402 may have a compressible body portion 410 with a cross-sectional shape substantially similar to the cross-sectional shape defined by the channel 402 shown in FIGS. 1-5. Preferably, the channel filler 402 is configured to compressibly fit into the channel 130 between the adjacent cushions 126 and extends along the the width 114 of the table 102. The channel filler 402 may be removeably retained in the channel 130 so as to provide a smooth transition between adjacent cushions 126 and in particular, along the upwardly-facing weight-bearing surface 128 of the cushions so as to effectively provide a continuously-supportive surface of the cushions.

Preferably, the channel filler 402, and in particular, the compressible body portion 410, has a cross-sectional shape substantially similar to the cross-sectional shape defined by the channel 130. The channel filler 402 may be manually inserted into the channel 130 under slight to moderate manual force so as to form a compressibly or frictional fit between the adjacent cushions 126. Preferably, the channel filler 402 extends along the entire width 114 or substantially the entire width of the table 102, but in some embodiments may only extend along a portion of the width 114. As shown in the figures, the channel filler 402 may provide a smooth transition between the adjacent cushions 126 and along the upwardly-facing weight-bearing surface 128 of the cushions such that the patient 122 lying on the weight-bearing surface 128 cannot feel or notice the channel 130, as it is filled by the channel filler 402.

Referring to FIGS. 4-8, to removeably retain the channel filler 402 in the channel 130, one or more or the securing straps 406 may be operatively affixed to opposite ends 610, 612 of the channel filler 402. The securing straps 406 may be configured to fasten together under the frame 106 or planar surface 108 to releasably secure the channel filler 402 in the channel 130. Each end 616, 618 of the securing strap 406 may be provided with male and female side-release plastic or metal buckles 620, similar to the buckles provides on backpack straps, which are able to take up slack in the strap so as to shorten or lengthen the strap so as to accommodate different size tables 102. In some embodiments, depending on the dimensions of the channel 130 and the compressible characteristics of the channel filler 402, a frictional fit may obviate the need for the straps 406.

The compressible body portion 410 of the channel filler 402 may be made of any suitable material, such as a deformable material, polyurethane foam, latex foam, memory foam, medium and high density polyurethane foam, dry-fast open cell foam, open cell polyurethane foam, closed cell foam, and the like. The material of the body portion 410 may have any suitable density, for example, between 1.5-20 pounds per cubic foot, and in some embodiments, preferably between 2-5 pounds per cubic foot. Any suitable material may be used.

Referring now to FIG. 8, the compressible body portion 410 shown in FIGS. 6-7 may include a shell or fabric casing 802, which encloses the body portion 410 and provides a convenient means for attaching the straps 406 at opposite ends. Each end 616, 618 of the strap 606 may be sewed to the fabric casing 802. Alternatively, any suitable method of affixing the ends 616, 618 of the strap 402 to the casing 802 may be used, such as by stitching, heat bonding if the casing is plastic or synthetic, or by suitable adhesive. The securing straps 406 are configured to fasten together under the frame 106 or planar surface 108 to releasably secure the channel filler 402 in the channel 130. The shell or fabric casing 802 may be formed of any suitable material, such as plastic, synthetic fabric, natural fabric, or any woven material. The casing 802 may provide a hygienic enclosure so at simplify cleaning and maintenance.

FIGS. 9A-9J show cross-sectional side views of the body portion 410 of the channel filler 402, particularly illustrating the different geometries which the body portion 410 may assume, such as triangular, V-shaped, rectangular, square, octagonal, hexagonal, circular or rounded, oval or elliptical, saddle-shaped, and the like.

Note that in FIG. 9A, the triangular cross-sectional shape of the body portion 410 may include a top flat side 902 and two adjacent flat sides 904 that meet at a vertex 906 opposite the flat side 902. Similarly, in FIG. 9B, the V-shaped cross-sectional shape of the body portion 410 may include a flat side 912 and two inwardly concave curved sides 914 that meet at a vertex or nose 916 opposite the flat side 912. In operation, the vertex 906, 916 is positioned in the channel 130 facing downwardly, and the top flat side 902, 912 faces upwardly to provide the smooth transition between the adjacent cushions 126.

FIG. 9J shows a preferred alternate embodiment of a cross-sectional shape of the body portion 410 or channel filler 402. FIG. 9J additionally shows representational dimensional information, which may vary depending upon the application and the type and size of table involved, and also depending upon the spacing between cushions. The other geometrical shapes of the multiple geometries of FIGS. 9A-9J of the channel filler 402 provide a similar function and may be used interchangeably. In some embodiments, as described in further detail below, the body portion 410 may have an optional throughbore or hollow portion 920 extending through the entirety of the body portion 410, as indicated by the dashed circular outline in FIGS. 9A-9J.

FIGS. 10A and 10B are perspective views of additional shapes that the channel filler 402 or body portion 410 may have, regardless of whether the casing 802 is included or is not included. However, the various shapes are not limited to the exact geometry suggested in FIGS. 9A-9J and 10A-10B, and any suitable shape may be used as the body portion 410, whether regular, geometric, or irregular.

FIGS. 11A-11B are perspective view of the body portion 410 according to one embodiment. This embodiment further illustrates once specific geometric shape shown in FIG. 9F, namely the hexagonal shape, and further illustrates the hollow throughbore 920. In this embodiment, the outer casing 820 may be unnecessary, and alternatively, the securing strap 406 may be received completely through the thoughbore 920 such that opposite ends 616, 618 of the securing strap 406 fasten together under the planar surface 108 to releasably secure the channel filler 402 in the channel 130. Use of the securing strap 406 extending entirely through the throughbore 920 may be used with any of the configurations shown in FIGS. 9A-9J, and further with any other suitable shape, whether regular, geometric, or irregular.

FIG. 12 is a perspective view of a body portion 410 having a similar shape as the body portion of FIGS. 9F, 11A, and 11B. In this specific embodiment, a stiffening member 1202 may be received within the hollow throughbore 920 and may extend through the throughbore. A first securing strap 1206 may be operatively attached to one end of the stiffening member 1202 and a second securing strap 1208 may be operatively attached to an opposite or second end of the stiffening member 1202. As in other embodiments, opposite ends of the securing straps 1206, 1208 may fasten together under the frame 106 or planar surface 108 to releasably secure the channel filler 402 in the channel 130. The stiffening member 1202 may be a round rod or a flat rod, and may be formed of any suitable material, such as plastic, wood, metal, and the like.

Many modifications and other embodiments of the disclosure set forth herein will come to mind to one skilled in the art to which these disclosed embodiments pertain having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the disclosure. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

While particular embodiments are illustrated in and described with respect to the drawings, it is envisioned that those skilled in the art may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims.

What is claimed is:

1. A table assembly having a plurality of cushions, comprising:
a table having a frame or a planar surface, the table having a width and a length;
a plurality of legs extending downwardly from the frame or the planar surface, the legs having sufficient structural integrity to support a weight of an object disposed on the frame or the planar surface;
the plurality of cushions fixedly attached to the frame or to a top side of the planar surface along a portion of the length, each cushion having an upwardly-facing weight-bearing surface;
a channel formed between adjacent cushions of the plurality of cushions and extending across a portion of a width of the cushions, the channel having a cross-sectional shape defined by a contour of edges of the adjacent cushions;
a channel filler having a compressible body portion with a cross-sectional shape configured to compressibly fit into the channel between the adjacent cushions and extend along the channel; and
wherein the channel filler is removeably retained in the channel so as to provide a smooth and supportive transition between adjacent cushions along the weight-bearing surface of the cushions.

2. The assembly of claim 1, further including securing straps operatively affixed to the channel filler and configured to fasten together under the frame or planar surface to releasably secure the channel filler in the channel.

3. The assembly of claim 1, further including:
an outer case configure to enclose the compressible body portion;
securing straps attached to opposite ends of the outer case; and
wherein ends of the securing straps are configured to fasten together under the frame or planar surface to releasably secure the channel filler in the channel.

4. The assembly of claim 3, wherein the outer case is made of a plastic material, a synthetic material, a fabric material, or a woven material.

5. The assembly of claim 1, wherein the body portion is made of polyurethane foam, latex foam, memory foam, medium density polyurethane foam, high density polyurethane foam, dry-fast open cell foam, open cell polyurethane foam, or closed cell foam.

6. The assembly of claim 1, wherein the cross-sectional shape of the body portion is triangular, V-shaped, rectangular, square, circular, hexagonal, octagonal, oval, elliptical, or saddle-shaped.

7. The assembly of claim 1, wherein the cross-sectional shape of the body portion includes a flat side and two inwardly concave curved sides meeting at a vertex or nose opposite the flat side, wherein the vertex or nose is positioned downwardly in the channel and the flat side provides the smooth transition between the adjacent cushions.

8. The assembly of claim 1, wherein the channel filler includes a throughbore through which a securing strap extends, and wherein opposite ends of the securing strap fasten together under the frame or planar surface to releasably secure the channel filler in the channel.

9. The assembly of claim 8, further including
a stiffening member received within the throughbore;
a first securing strap operatively attached to one end of the stiffening member;
a second securing strap operatively attached to an opposite end of the stiffening member; and
wherein opposite ends of the securing straps fasten together under the frame or planar surface to releasably secure the channel filler in the channel.

10. The assembly of claim 1, wherein the cushions have a rigid planar bottom surface configured to attach directly to the frame.

11. The assembly of claim 1, wherein the channel is defined by the cross-sectional shape of the contour of edges of the adjacent cushions and by a distance between the adjacent cushions on the planar surface.

12. A channel filler for use in a table having a frame or planar surface, having a width and a length, and a plurality of cushions attached to the frame or planar surface, each cushion having a weight-bearing surface, the channel filler comprising:
a compressible body portion configured to compressibly fit into a channel formed between adjacent cushions;
the channel extending along the width of the frame or planar surface and defined by a distance between the adjacent cushions, wherein the channel has a cross-sectional shape defined by a contour of edges of the adjacent cushions;
the compressible body portion having a cross-sectional shape substantially similar to the cross-sectional shape defined by the channel; and
wherein the channel filler is removeably retained in the channel so as to provide a smooth and supportive transition between adjacent cushions along the weight-bearing surface of the cushions.

13. The channel filler of claim 12, further including securing straps operatively affixed to the channel filler and configured to fasten together under the frame or planar surface to releasably secure the channel filler in the channel.

14. The channel filler of claim 12, further including:
an outer case configure to enclose the compressible body portion;
securing straps attached to opposite ends of the outer case; and
wherein ends of the securing straps are configured to fasten together under the frame or planar surface to releasably secure the channel filler in the channel.

15. The channel filler of claim 14, wherein the outer case is made of a plastic material, a synthetic material, a fabric material, or a woven material.

16. The channel filler of claim 12, wherein the body portion is made of polyurethane foam, latex foam, memory foam, medium density polyurethane foam, high density polyurethane foam, dry-fast open cell foam, open cell polyurethane foam, or closed cell foam.

17. The channel filler of claim 12, wherein the cross-sectional shape of the body portion is triangular, V-shaped, rectangular, square, circular, hexagonal, octagonal, oval, elliptical, or saddle-shaped.

18. The channel filler of claim 12, wherein the cross-sectional shape of the body portion includes a flat side and two inwardly concave curved sides meeting at a vertex or nose opposite the flat side, wherein the vertex or nose is positioned in the channel and the flat side provides the smooth transition between the adjacent cushions.

19. The channel filler of claim 12, wherein the channel filler includes a hollow bore through which a securing strap extends, and wherein opposite ends of the securing strap fasten together under the frame or the planar surface to releasably secure the channel filler in the channel.

20. The channel filler of claim 12, wherein the channel is defined by the cross-sectional shape of the contour of edges of the adjacent cushions and by a distance between the adjacent cushions on the planar surface.
